(19) United States
(12) Patent Application Publication
(10) Pub. No.: US 2004/0019123 A1
(43) Pub. Date: Jan. 29, 2004

(54) Multi-phase suspension coolant

(76) Inventors: Sehoon Kwak, Auburn Hills, MI (US); Karl Holdik, Rochester Hills, MI (US)

Correspondence Address: DAIMLERCHRYSLER INTELLECTUAL CAPITAL CORPORATION, CIMS 483-02-19, 800 CHRYSLER DR EAST, AUBURN HILLS, MI, 48326-2757, US

(21) Appl. No.: 10/205,661

(22) Filed: Jul. 24, 2002

(51) Int. Cl. C09K 3/00

(52) U.S. Cl. 516/53

(57) ABSTRACT

A polymer encapsulated solid-liquid or a solid-solid phase change material for use in a fluid coolant heat exchange system is disclosed. The resulting coolant has a higher heat transfer rate than a conventional fluid due to the utilization of the heat of fusion of the material. Thus provided, the improved coolant will allow down sizing of the coolant pump and subsequent reduction of parasitic loading. Engine heat up time can be increased due to the lower coolant flow rate and heat transfer capability at below operating range temperatures.

### CROSS-REFERENCE TO RELATED APPLICATIONS

1. Field of the Invention

The present invention relates to a method of transporting heat energy in a fluid system that incorporates solid-solid or solid-liquid phase change materials contained within polymer capsules, such as a polymer encapsulated wax.

### BACKGROUND OF THE INVENTION

Automotive engine coolant systems typically remove heat energy from an engine by circulating a fluid through passages within the engine to absorb heat and then through a radiator or other heat dissipation device. Generally, the fluid is a mixture of water and ethylene glycol and is forced through a circulatory cycle by utilizing a pump. U.S. Pat. No. 6,364,213 discloses a typical automotive cooling system.

Fluid heat exchange media can be enhanced with a suspension of materials that undergo a phase change within the thermal operating range of an automotive engine cooling system. U.S. Pat. No. 6,284,158 discloses a solid porous structure with a solid-liquid phase change material absorbed therein for use in enhancing the heat absorption efficiency of a fluid. U.S. Pat. No. 3,596,713 discloses an encapsulated solid-liquid phase change material with a non-neutral buoyancy in a cooling system.

The difficulty with utilizing a suspension of phase change materials within a fluid cooling system is that the phase change materials can coalesce into a large suspension size thereby reducing the cooling efficiency or cause blockages which could lend to system failure. Encapsulation of a solid-liquid phase change material will limit aggregation of the dispersed suspensions but can also result in an undesired accumulation of phase change materials due to a non-neutral buoyancy. What is needed is a phase change material that has an optimum phase transition point for automotive applications, a durable encapsulation that is well suited for use in a cooling system, a neutral buoyancy and dispersant mechanism to prevent undesired accumulation.

### SUMMARY OF THE INVENTION

In one aspect of the present invention a polymer encapsulated solid-liquid phase change material is dispersed in a fluid medium such as a mixture of water and ethylene glycol. This fluid is pumped in a closed loop between a heat source and a heat sink. The encapsulated phase change material has a phase transition point that is within the temperature range of the coolant loop.

In another aspect of the present invention, a solid-solid phase change material can be dispersed in the fluid medium. A solid-solid phase change material may not require encapsulation. It can be neutrally buoyant, have self-dispersing characteristics and not react chemically with the continuous phase. The solid-solid phase change material can be encapsulated.

As the fluid comes in contact with a surface of the heat source, the fluid absorbs heat energy. The encapsulated phase change materials entrained in the fluid absorb heat energy from the fluid as the temperature of the surrounding fluid rises. Preferably, the fluid travels through channels or bores within the heat source to maximize heat transfer surface area and contain the fluid. As the capsules absorb heat energy, the phase change materials experience an increase in temperature and reach phase transition point. These materials could be solid-liquid phase change materials, such as wax, or solid-solid phase change materials, such as tetrahalometallates or trans-1,4 polybutadiene. Additional absorption of heat energy into the entrained capsules will result in phase change of the encapsulated material. As the phase change material undergoes transition, a relatively large amount of heat energy can be absorbed by the phase change material when compared to an equivalent volume of fluid. This large amount of heat energy absorption is due to the latent heat associated with the phase change material. The phase change material is selected from materials that possess a desirable latent heat and phase transition point and chemical compatibility with the coolant and encapsulating material (if any).

The fluid and entrained phase change materials are then diverted to a heat sink which is maintained at a lower temperature than the heat source. When the fluid contacts a surface of the heat sink, the heat sink will absorb heat energy from the fluid thereby reducing the temperature of the fluid. As the temperature of the fluid is reduced below the temperature of a capsule surface, the fluid will absorb heat energy from the capsule thus reducing the temperature of the capsule. As the resulting transfer of heat energy lowers the temperature of the phase change material within the capsule to the phase transition point of the phase change material, solidification will occur for a solid-liquid phase change material. This resulting phase change will release a relatively large amount of heat energy into the fluid when compared to an equivalent volume of fluid. The encapsulated phase change material provides a more efficient transfer of heat energy when compared to a fluid with no capsules. Thus provided, less volumetric flow of coolant is required in a preferred embodiment of the present invention to dissipate an equivalent amount of heat energy than in a conventional coolant system. With a lower volumetric flow of coolant, pump work loss is reduced. Additionally, a lower volumetric flow will allow the heat source to more rapidly reach the phase transition point.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a diagram of the cooling system of the present invention.

FIG. 2 is an enlarged, sectional view of the capsules of the present invention.

### DETAILED DESCRIPTION OF THE PREFERRED EMBODIMENTS

The following description of the preferred embodiment(s) is merely exemplary in nature and is in no way intended to limit the invention, its application, or uses.

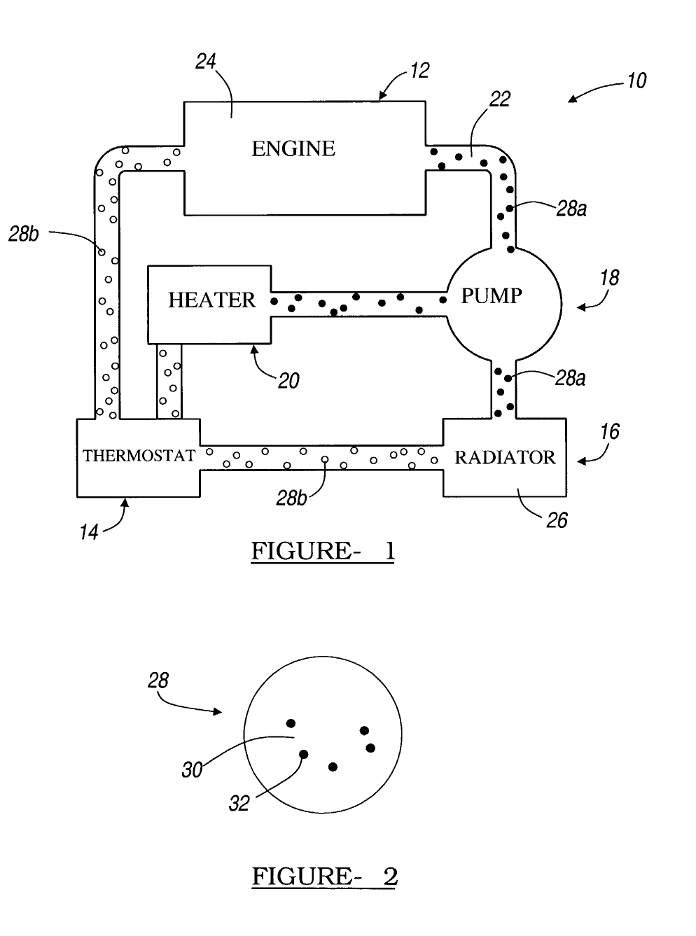

Referring to FIG. 1, a schematic diagram of a cooling system 10 is shown wherein an engine 12 is in fluid communication with a thermostat 14, a radiator 16, pump 18 and heater 20. A fluid 22 is circulated through cooling system 10 by pump 18. Engine 12 creates excess heat energy and is supplied with a heat exchange surface 24 whereby fluid 22 absorbs heat energy upon contacting heat exchange surface 24. Radiator 16 has a heat absorption surface 26 which contacts fluid 22 as fluid 22 circulates through radiator 16. In this manner, heat absorption surface 26 of radiator 16 absorbs heat from fluid 22.

Radiator 16 is preferably an air-cooled single pass conventional heat exchange device. Thermostat 14 is preferably adapted to regulate the flow of fluid 22.

Capsules 28 are dispersed within fluid 22. Preferably capsules 28 maintain a neutral buoyancy within fluid 22 to encourage a generally equal distribution of capsules 28 throughout the volume of cooling system 10.

With reference to FIG. 2, capsules 28 are shells which contain phase change material 30. Phase change material 30 is selected from materials that have a melting point within the temperature extremes of cooling system 10. Preferably, capsules 28 are constructed of a polymer. Capsules 28 have a diameter in the range of 1 to 700 microns with a preferable diameter on the order of 50 to 100 microns. The preferable range for skin thickness of capsules 28 is on the order of 1 to 5 microns. For a solid-liquid phase change material 30, capsules 28 are shown in FIG. 1 as capsules 28A when phase change material 30 is in the solid phase. Capsules 28 are shown as capsules 28B when phase change material 30 is in the liquid phase as a result of absorbed heat energy from engine 12. When phase change material 30 is entirely a solid-solid material, capsules 28A and capsules 28B would both be a solid phase.

Solid-liquid phase change material 30 preferably includes a paraffin, hydrate or wax-type material. For selected phase change material with a density lower than water, a preferred embodiment includes weights 32 within capsules 28 to ensure neutral buoyancy with fluid 22. Weights 32 are preferably metallic particles. The density of capsules 28 can also be adjusted with phase change materials 30 and polymers selected for their densities.

Solid-solid phase change material 30 preferably includes materials that undergo a transition from one solid phase to another as the temperature of the material changes.

Phase change material 30 may experience a volumetric change with a solid/liquid or solid/solid phase change. Capsules 28 are preferably sufficiently deformable or are partially filled with phase change material to accommodate this volumetric change. While solid-liquid phase change material 30 is preferably paraffin, it would be recognized by one skilled in the art that different materials, selected for a desirable latent heat and phase transition, could also be used. Additionally, different phase change materials 30 can be included within a single capsule, or within separate capsules, or with no encapsulation, to obtain a favorable operating temperature gradient within engine 12 or radiator 16. Thus provided, capsules 28 are adapted to transport phase change material 30 through a cooling system 10 to increase the heat exchange efficiency of fluid 22.

The description of the invention is merely exemplary in nature and, thus, variations that do not depart from the gist of the invention are intended to be within the scope of the invention. Such variations are not to be regarded as a departure from the spirit and scope of the invention.

What is claimed is:

1. A multiphase suspension coolant comprising:
a fluid;
a phase change material; and
a capsule adapted to enclose said phase change material, said capsule adapted to maintain a neutral buoyancy within said fluid.

2. The multiphase suspension coolant system of claim 1, wherein said phase change material further comprises a wax.

3. The multiphase suspension coolant of claim 1, wherein said phase change material further comprises paraffin.

4. The multiphase suspension coolant of claim 1, wherein said capsule is constructed of a polymer.

5. The multiphase suspension coolant of claim 1, further comprising weights within said phase change material, said weights adapted to promote neutral buoyancy within said fluid.

6. A coolant suspension for increasing the efficiency of a coolant comprising:
a phase change material; and
a capsule, said capsule constructed of a polymer, said capsule enclosing a quantity of said phase change material said capsule adapted to maintain a generally neutral buoyancy in said coolant.

7. The coolant suspension of claim 6, wherein said phase change material includes wax.

8. The coolant suspension of claim 6, wherein said phase change material includes paraffin.

9. The coolant suspension of claim 6, further comprising a weight of a substance with a density greater than the density of said coolant, said weight adapted to maintain said capsule at a generally neutral buoyancy in said coolant.
